(19) United States
(12) Patent Application Publication
(10) Pub. No.: US 2026/0371300 A1
(43) Pub. Date: Nov. 19, 2026

(54) SYSTEMS AND METHODS TO CONTROL A USER DEVICE USING LOCATION-BASED POSITIONING TECHNOLOGY

(71) Applicant: The Commons, Saint Paul, MN (US)

(72) Inventors: Julia Gustafson, Saint Paul, MN (US); Shannon Godfrey, Long Beach, CA (US)

(73) Assignee: The Commons, Saint Paul, MN (US)

(21) Appl. No.: 19/211,372

(22) Filed: May 19, 2025

(51) Int. Cl. H04W 64/00; H04W 8/22

(52) U.S. Cl. CPC H04W 64/00; H04W 8/22

(57) ABSTRACT

A system to control a user device associated with a user is disclosed. The system includes an access control unit that includes a memory and a processor. The memory stores usage rules. The processor obtains the usage rules from the memory, and transmits the usage rules to an agent located on the user device. The processor enforces a restriction on the user device based on the usage rules when the user device is located in a predefined area. The agent obtains the usage rules from the access control unit, and monitors a location of the user device responsive to obtaining the usage rules. Based on the monitoring, the agent determines that the user device is entering the predefined area, and activates a VPN based on the usage rules to enable the access control unit to enforce the restriction on the user device via the VPN.

### FIELD

The present disclosure relates to controlling a user device, and more specifically to a system and method to control a user device using location based positioning technology.

### BACKGROUND

Education institutes face significant challenges from unrestricted phone use among students. Distractions caused by constant notifications, social media and mobile games make it difficult for students to concentrate during classes, often leading to lower academic performance of the students. Beyond academics, excessive phone use has been linked to rising concerns around student mental health, including increased anxiety, social withdrawal, and disrupted sleep patterns - particularly among adolescents. Cheating is another major concern, as students may look up answers online or share test materials using their devices.

To overcome these challenges, the education institutes have adopted a few policies. For example, education institutes use lockable phone pouches that allow students to keep their phones but prevent access until the end of the day. Lockable phone pouches help reduce the distractions but face issues like students tampering with or secretly bypassing them.

Accordingly, there is a need for a system and method that reliably prevents student access to personal devices within an educational environment—supporting both academic integrity and student well-being.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an environment in which techniques and structures for providing the systems and methods disclosed herein may be implemented.

FIG. 2 depicts a block diagram of a system to control a user device in accordance with the present disclosure.

FIG. 3 depicts an exemplary signal line diagram to control a user device in accordance with the present disclosure.

FIG. 4 depicts a first example view of an admin interface displaying a student overview in accordance with the present disclosure.

FIG. 5 depicts a second example view of an admin interface displaying student details in accordance with the present disclosure.

FIG. 6 depicts a third example view of an admin interface displaying an overall dashboard with a recommendation in accordance with the present disclosure.

FIG. 7 depicts a flow diagram of an example method to control a user device in accordance with the present disclosure.

### DETAILED DESCRIPTION

### Overview

The present disclosure describes a system and method to prevent a user (e.g., a student) from using a user device (e.g., a mobile device or phone) inside a geographical area (e.g., an education institute). The system facilitates in managing and enforcing user device-free zones (or “smart zones”) effectively in the geographical area, thereby preventing distractions caused due to the use of user device inside the geographical area and enhancing user performance.

The smart zone may be a predefined zone or area (or a geofenced zone or a restricted zone) in which the system may prevent the use of the user device. The smart zone may define a geographic boundary or perimeter of the geographical area which may trigger the system to activate and enforce restrictions inside the smart zone. The system utilizes geofencing technology or any location / perimeter-based positioning technique to create the smart zones and prevent the use of the user device inside the smart zone. It may be appreciated that geofencing creates a virtual boundary or perimeter around a real-world geographic location using GPS or network data. The boundary can be circular or custom-shaped, defined by coordinates. The system enforces restrictions on the usage of user device when the user device enters the smart zone (such as the education institute or designated areas inside the education institute). The system may enforce the restrictions based on usage rules that are created/defined by an administrator (e.g., the education institute’s administrator, or the system’s administrator or developer/manager). The usage rules may be associated with the restrictions to be enforced on the user device when the user device is located in the smart zone.

For example, based on the usage rules, the system may deactivate/disable/block third party applications (e.g., applications associated with social media, entertainment, etc.), a network (e.g., Wi-Fi, mobile data plan, etc.), or other device functionality associated with the user device when the user device is located inside the smart zone. The system may disable all the third-party applications, or may selectively disable one or more third party applications installed on the user device and selectively allow other third-party applications (e.g., health related applications) to operate on the user device based on the usage rules. Further, the usage rules may include information associated with a defined schedule of the day (e.g., class hours between 8 AM to 3 PM or specific hours during evenings or weekends) to activate/enforce the restriction on the user device, a defined day or days (e.g., weekdays, weekends, or specific calendar dates) to enforce the restriction on the user device, a defined location or zone in the smart zone (e.g., library, classrooms in the education institute, dormitories, or other designated areas) to enforce the restriction on the user device, and/or the like.

In some aspects, the system utilizes an agent located on the user device associated with the user, to enforce the restrictions described above. The agent may include instructions stored thereupon which, when executed by a user device processor, cause the user device processor to enable the system to enforce/implement restrictions on the user device. The system may be hosted on a server, and may communicatively couple with the agent via a network connection.

In some aspects, the system and the agent may actively limit applications, network traffic and native capabilities of the device while within the smart zone. The system and the agent may use one or more content filtering, tunneling, or network-routing mechanisms, such as a Virtual Private Network (VPN), application blocking, or equivalent technology to restrict the user device’s usage inside the smart zone. In some aspects, the system and the agent may establish a VPN connection for the user device to restrict the user device usage inside the smart zone. It may be appreciated that the VPN routes all internet traffic through a controlled gateway where restrictions may be enforced. This allows the system to block/restrict the user device usage, such as prevent the user from accessing websites, social media apps, internet, etc.

In further aspects, the system may monitor compliance status of the user device (e.g., via the agent) and may log the compliance status in a system memory. The compliance status may be associated with a predefined permission for the agent to enable the system to enforce the restriction on the user device. In an exemplary aspect, the user device may be in a non-compliant state when the user disables the predefined permission (e.g., location tracking feature and/or the VPN) for the agent to operate properly. In another exemplary aspect, the user device may be in the non-compliant state when the user removes/deletes the agent from the user device. On the other hand, the user device may be in the compliant state when the agent has the predefined permission to operate properly on the user device and the user has not removed the agent from the user device.

Responsive to determining that the user device is in the non-compliant state, the system may perform one or more remedial actions (e.g., outputting an alert notification to the user device and/or to a third party such as parent, supervisor/teacher, etc.). The system may further monitor user device usage (e.g., active screen time) when the user device is inside the smart zone. In some aspects, the system may monitor the user device usage when the user device may be in the non-compliant state, and may store such information in the system memory.

The system may further generate and render a dashboard depicting the compliance status and/or the user device usage information (real-time and historical data) on an admin interface associated with the administrator (e.g., on a computing device associated with the administrator). The dashboard may further include user performance (e.g., academic performance associated with the user). The dashboard may enable the administrator to view different information about the user collectively, correlate all the information and counsel the user based on the correlation. In some aspects, the system may correlate the user performance and the other information (including the compliance status and/or the user device usage information), and determine a recommendation to improve the user’s performance based on the correlation. The system may further predict a future performance outcome of the user based on the correlation, and may display a notification indicating the prediction and/or the recommendation on the user device and/or the admin interface.

The system may also track device usage patterns and compliance status to generate insights around engagement, productivity, or adherence to location-specific policies - whether for academic, operational, or safety-related outcomes. This enables administrators or supervisors across educational, professional, or event-based environments to make informed decisions that support well-being, performance, and policy effectiveness.

The present disclosure discloses a system to enforce phone-free zones effectively in an education institute, and prevent distraction caused due to phone usage inside the education institute, thereby enhancing academic performance. The system enhances student/user engagement, focus, and learning during education institute hours. The system drives change in learning environment through sustainable policy and program fidelity. The system further encourages presence, meaningful relationships and positive behavior by removing social media, increasing phone-use awareness and providing learning opportunities for digital citizenship. The system further enables the supervisors/teachers to focus on providing learnings to the users rather than monitoring the users and preventing them to use phones during classes.

The system automatically removes the ability to use social media applications from the user’s phones, and provides data-driven visibility to support policy enforcement and sustainability. Real-time dashboards provide visibility into active/inactive users allowing school administrators quick access to necessary interventions if needed during operational hours within education institute premises under defined schedules set forth by respective authorities managing these systems effectively without any hassle. The system tracks active screentime to promote student self-awareness but also to assist administrators in identifying patterns of overuse or noncompliance that may serve as indicators of disengagement, behavioral concerns, or the need for additional support or intervention. The system further enables real-time engagement and compliance monitoring.

These and other advantages of the present disclosure are provided in detail herein. By providing flexible enforcement and monitoring tools, the system is well-suited for a variety of environments where controlled use of personal mobile devices supports individual performance, policy compliance, or safety protocols.

While the present disclosure emphasizes education-related use cases, the system and methods described herein are equally applicable in other environments where digital distraction poses operational, safety, or productivity concerns such as corporate offices, events, training facilities, or entertainment venues. Accordingly, the “user” may refer to any individual carrying a mobile device including, but not limited to, students, employees, event participants, or attendees at public or private venues.

The disclosure will be described more fully hereinafter with reference to the accompanying drawings, in which example embodiments of the disclosure are shown, and not intended to be limiting.

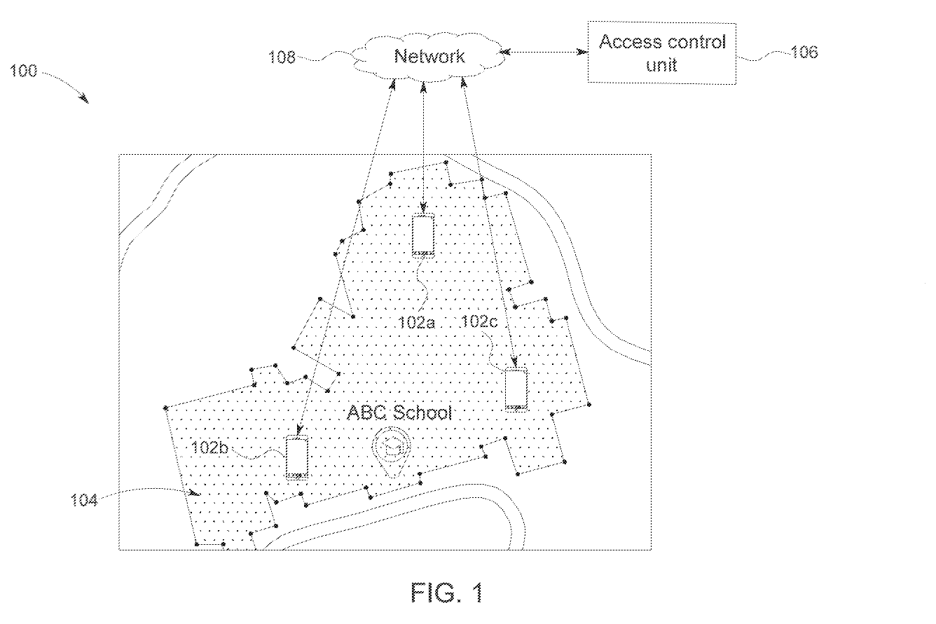

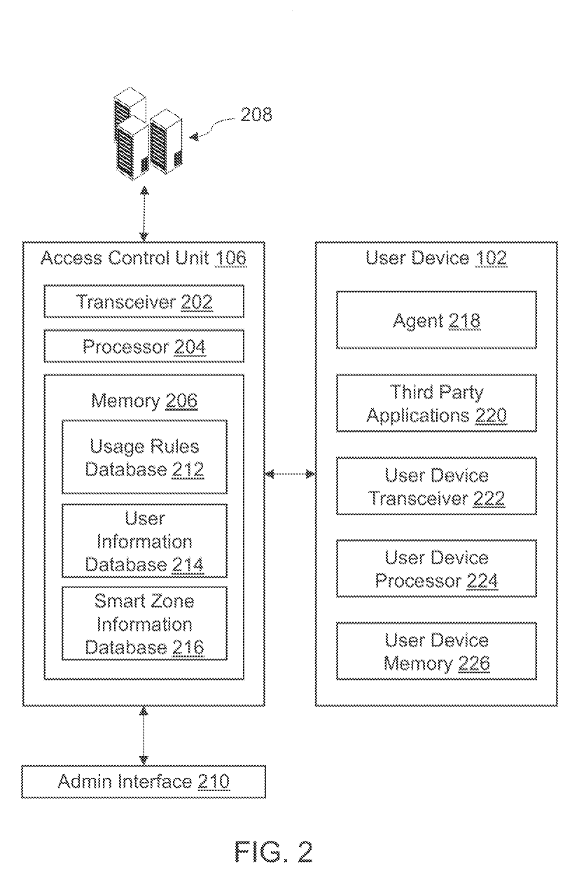

FIG. 1 depicts an environment 100 in which techniques and structures for providing the systems and methods disclosed herein may be implemented. FIG. 1 will be described in conjunction with FIGS. 2, 3, 4, 5 and 6.

The environment 100 may include one or more user devices 102a, 102b, 102c (collectively referred as user device 102), which may be associated with one or more users (e.g., students of an education institute, employees of a corporate, etc.). The user device 102 may be, for example, a mobile phone, a laptop, a tablet, a smartwatch, or any other similar device with communication capabilities.

The environment 100 may further include a smart zone 104 (which may be a geofenced zone or a restricted zone). The smart zone may define a geographic boundary or perimeter of a geographical area. In some aspects, the smart zone may be created by using geofencing technology or any location / perimeter-based positioning technique. It may be appreciated that geofencing creates a virtual boundary or perimeter around a real-world geographic location using Global Positioning System (GPS) or other means of position interpretation such as beacons or network data. The boundary may be circular, polygonal, or custom-shaped, defined by coordinates. The geographic location may include, but is not limited to, an education institute, a workplace (e.g., an office), a room in a home, a factory / plant, a mill, and/or the like.

The environment 100 may further include an access control unit 106 (or unit 106) that may control the usage of the user device 102 inside the smart zone 104. For example, the unit 106 may deactivate or disable (or alternatively selectively activate or enable) third party applications (e.g., applications associated with social media, entertainment, etc.), a network (e.g., a network 108 described below), or other device functionality associated with the user device 102 when the user device 102 is located inside the smart zone 104. The unit 106 may disable all the third-party applications, or may selectively disable one or more third party applications installed on the user device 102 and selectively allow other third-party applications (e.g., health related applications) to operate. The unit 106 may customize restrictions for the user device 102 based on the preferences of an administrator (e.g., an education institute’s administrator, or unit’s administrator or developer/manager). The unit 106 may communicatively couple with the user device 102 via the network 108.

The network 108, as described above, illustrates an example communication infrastructure in which the connected devices discussed in various embodiments of this disclosure may communicate. The network 108 may be and/or include the Internet, a private network, public network or other configuration that operates using any one or more known communication protocols such as transmission control protocol/Internet protocol (TCP/IP), Bluetooth^{®}, Bluetooth^{®} Low Energy (BLE), Wi-Fi based on the Institute of Electrical and Electronics Engineers (IEEE) standard 802.11, ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

The environment 100 may further include an agent (shown as agent 218 in FIG. 2) that may be installed on the user device 102. In an exemplary aspect, the agent 218 may be an application (“app”) associated with the unit 106 that may be located on the user device 102. The agent 218 may be communicatively coupled with the unit 106 via the network 108. The agent 218 may enable the unit 106 to activate the restrictions on the user device 102 when the user device 102 may be located in the smart zone 104. The agent 218 may receive a trigger signal when the user device 102 enters the smart zone 104, and may enable the unit 106 to activate the restrictions on the user device 102 when the user device 102 is located inside the smart zone 104.

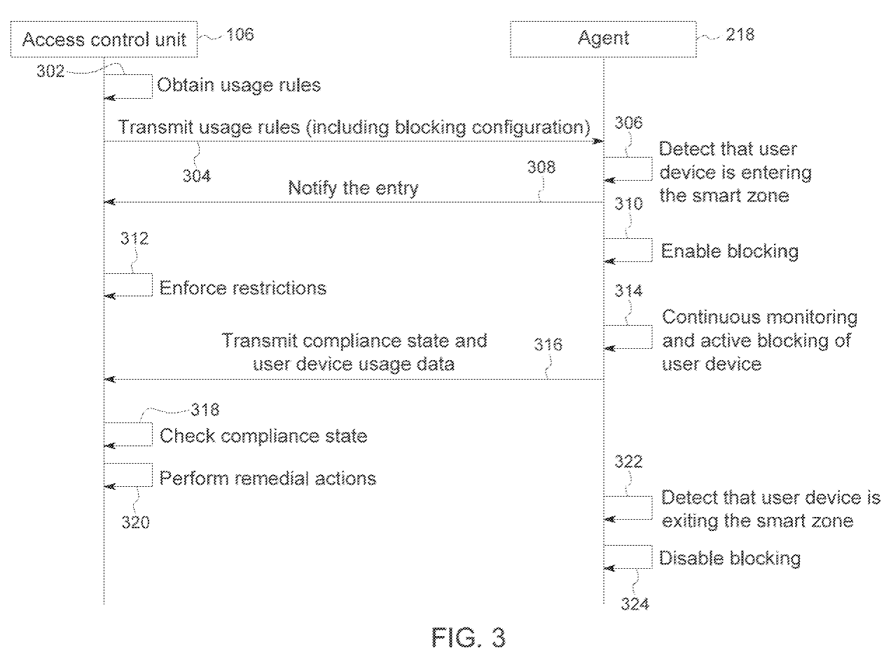

In some aspects, the unit 106 and the agent 218 may actively limit applications, network traffic and native capabilities of the user device 102 while within the smart zone 104. The unit 106 and the agent 218 may use one or more of content filtering, tunneling, or network-routing mechanisms, such as a Virtual Private Network (VPN), application blocking, or equivalent technology to restrict the user device’s usage inside the smart zone 104. In some aspects, the unit 106 and the agent 218 may establish a VPN connection for the user device 102 to restrict the user device usage inside the smart zone 104. It may be appreciated that the VPN routes all internet traffic through a controlled gateway where restrictions may be enforced. This allows the unit 106 to block/restrict the user device usage, such as prevent the user from accessing certain websites, social media apps, Internet, etc. The details of actions performed by the unit 106 and the agent 218 installed on the user device 102 are described later in the described below (e.g., in conjunction with FIG. 3).

The unit 106 may include a plurality of components including, but not limited to, a transceiver 202, a processor 204 and a memory 206, as shown in FIG. 2. The unit 106 may be communicatively coupled or integrated with an external server 208 via the network 108. In some aspects, the external server 208 may be associated with the education institute and may be managed by the education institute. For instance, the external server 208 may store details associated with all the students/users in different classes (e.g., student name, historical grades associated with each student or historical student performance, supervisors/teachers’ information for each class (e.g., supervisor name, total experience, etc.), curriculum of each subject/supervisor, and/or the like). An administrator may use the unit 106 (and the agent 218 installed on the user device 102) to enforce the restriction on the user device 102, via an admin interface 210 (that may be rendered on a computing device associated with the administrator).

The transceiver 202 may receive data / information / signals from the unit 106 components and/or external systems, e.g., the user device 102 via the network 108 described above. For example, the transceiver 202 may receive location information associated with the user device 102 from the agent 218, other information (e.g., real-time user device usage data) associated with the user device 102 from the agent 218, details of students/users from the external server 208, and/or the like. The transceiver 202 may further output information/data on the admin interface 210, the user device 102, etc. In some aspects, the transceiver 202 may exchange information/data with the agent 218 (and other devices) in a secured environment so that there is no compromise/leakage of data while data exchange. In an exemplary aspect, all communications use TLS 1.2 or higher to ensure data security over-the-wire.

The processor 204 may utilize the memory 206 to store programs in code and/or to store data for performing aspects in accordance with the disclosure. The memory 206 may be a non-transitory computer-readable storage medium or memory storing a program code that enables the processor 204 to perform operations in accordance with the present disclosure. The memory 206 may include any one or a combination of volatile memory elements / media (e.g., dynamic random-access memory (DRAM), synchronous dynamic random-access memory (SDRAM), etc.) and may include any one or more nonvolatile memory elements / media (e.g., erasable programmable read-only memory (EPROM), flash memory, electronically erasable programmable read-only memory (EEPROM), programmable read-only memory (PROM), etc.).

In some aspects, the memory 206 may include a plurality of databases including, but not limited to, a usage rule database 212, a user information database 214 and a smart zone information database 216. The usage rule database 212 may store usage rules associated with the restrictions to be enforced on the user device 102 when the user device 102 may be located in the smart zone 104. The administrator (e.g., the unit developer/manager or the education institute’s administrator) may define/create the usage rules on the unit 106 (e.g., via the admin interface 210), which may be stored on the usage rule database 212.

The usage rules may include location information associated with the smart zone 104 (that may enable the agent 218 to know the smart zone boundary), and the restriction to be enforced on the user device 102 when the user device 102 is inside the smart zone 104. For example, the usage rules may define that the unit 106 should deactivate third party applications (e.g., applications associated with social media, entertainment, etc.), the network 108, and/or the other device functionality associated with the user device 102 when the user device 102 is located inside the smart zone 104. The unit 106 may customize the restrictions for the user device 102 based on the administrator’s preferences that the administrator defines in the usage rules, via the admin interface 210.

Further, the usage rules may include information associated with a defined schedule of the day to activate/enforce the restriction on the user device 102 (e.g., enforce the restriction between 8 AM to 2 PM), a defined day or days (e.g., weekdays, weekends, or specific calendar dates) to enforce the restriction on the user device 102 (enforce the restriction on weekdays), a defined location or zone in the smart zone 104 (e.g., library, classrooms, event place in the education institute) to enforce the restriction on the user device 102, and/or the like. The usage rules may be associated with the smart zone 104 (e.g., the education institute) and may be defined/created by the administrator via the admin interface 210. In addition, the administrator may set the virtual boundaries for geofencing a geographical location, such as the education institute, or define the smart zone 104 via the admin interface 210.

The user information database 214 may store information associated with students / users associated with the education institute. The transceiver 202 may obtain the user details / information from the external server 208 and store the details in the user information database 214. The administrator may modify/update the user’s details in the user information database 214 anytime via the admin interface 210. The smart zone information database 216 may include details associated with the smart zone 104, which may include, e.g., perimeter details and/or location details associated with the smart zone 104. The administrator may customize the details associated with the smart zone 104 via the admin interface 210. In some aspects, the smart zone information database 216 may be part of the usage rule database 212. In other aspects, the smart zone information database 216 may be separate from the usage rule database 212, as depicted in FIG. 2.

The user device 102 may include a plurality of components / units including, but not limited to, the agent 218 associated (or communicatively coupled) with the unit 106, third party applications 220, a user device transceiver 222, a user device processor 224 and a user device memory 226. The agent 218 may be located on the user device 102. The agent 218 may include instructions stored thereupon which, when executed by the user device processor 224, cause the user device processor 224 to enable the unit 106 to enforce/implement the restriction on the user device 102 (and control other operations, as described below). The user device transceiver 222 may exchange data/information with external devices/systems. For instance, the user device transceiver 222 may exchange data/information with the unit 106. The user device processor 224 may be similar to the processor 204, and the user device memory 226 may be similar to the memory 206.

In operation, the unit 106 may obtain a list of users/students (along with their respective user information such as user names, grades, etc.) from the external server 208 via the network 108, for whom the restrictions are required to be enforced on their respective user devices when the user devices are located in the smart zone 104. In some aspects, the unit 106 may obtain the list from the external server 208 at a predefined frequency (e.g., to maintain an updated list of users). The unit 106 may generate a unique quick-response (QR) code for each user, responsive to obtaining the list and the respective user information. It may be appreciated that a QR code is a way to store information visually using a pattern of black and white squares. It’s like a barcode, which can hold more complex data, such as a link to install the agent 218 (or an application associated with the unit 106). The unit 106 may transmit the QR code for each user to the administrator, who may distribute the QR codes to respective users. Alternatively, the unit 106 may directly transmit the QR codes to respective user devices.

Each user may use the unique QR code to install the agent 218 on the user device 102 associated with the user. The unit 106 may leverage the QR code to communicatively couple or link the unit 106 with the user device 102. Stated another way, the QR code may enable the unit 106 to pair with the user device 102. In some aspects, the user may use the QR code for one-time activation of the agent 218 on the user device 102, and to pair the user device 102 with the unit 106. Stated another way, the unit 106 may generate the unique QR code for each user device associated with the user, and enable the user to install the agent 218 on the user device 102 by using the QR code to communicatively couple or link the user device 102 with the unit 106. The QR code may allow the user device 102 to activate the agent 218 on the user device 102.

In an exemplary aspect, the unit 106 may store a mapping of each generated QR code with the respective user information (obtained from the external server 208), which may enable the unit 106 to identify the user device (e.g., a user device ID) associated with the respective user. Stated another way, the unit 106 may match the QR code to the user identity (or user information) to link the user device 102 with the user (or authenticate the user device 102). Thus, the QR code may enable the unit 106 to uniquely identify the user device 102 and the user associated with the user device 102. In this way, the user is not required to provide any Personally Identifiable Information (PII) on the user device 102, and the unit 106 may automatically identify that the user device 102 belongs to the user by using the unique QR code associated with the user. In some aspects, the unit 106 may utilize local encrypted storage via Hive database for storing sensitive information like the user device ID and the user information.

In this manner, the unit 106 may perform secure device authentication using roster-based authentication and not user-based authentication. A roster provides a list of users (students, teachers, etc.) and their associated roles or groups, which may be maintained in a student information system (SIS) or student management system (SMS) (which may be part of or stored on the external server 208). As described above, the external server 208 may be maintained by the education institute (as an example). Roster-based authentication refers to synchronizing user accounts and permissions from the external server 208 with the unit 106. The unit 106 automatically adds, removes, and updates users based on the data in the roster (or the external server 208), ensuring that the users have appropriate access to the services associated with the unit 106. In some aspects, the authentication process uses a temporary token that allows the agent activation but does not link to the personal user records. In scenarios where extra verification is required, the unit 106 may request for last four digits of a code, which is not stored beyond an initial validation.

When the agent 218 is installed / located in the user device 102, the agent 218 may output a notification on a user device interface, requesting the user to enable one or more predefined permissions (or necessary permissions) for the agent 218 to operate on the user device 102 (e.g., to enforce the restriction on the user device 102 via the unit 106). The predefined permissions may include access to multiple device capabilities including but not limited to, a permission to track location of the user device 102 and/or a permission to establish a VPN connection to enable the unit 106 to enforce the restriction on the user device 102 via the VPN. The user may view the notification on the user device interface and may enable/accept the predefined permissions to allow the agent 218 to operate or run on the user device 102. When the user approves or enables the predefined permissions on the user device 102, the agent 218 and the unit 106 may perform actions that are described below in conjunction with FIG. 3.

The processor 204 may first obtain / fetch the usage rules associated with the user device 102 from the usage rules database 212, as shown in a step 302. As described above, the usage rules may include information associated with the smart zone 104 and the restriction to be enforced on the user device 102 inside the smart zone 104. The processor 204 may transmit the usage rules to the agent 218 via the network 108 and the transceiver 202, responsive to obtaining the usage rules, as shown in a step 304. In some aspects, the usage rules may include a blocking configuration (e.g., a VPN configuration) that may actively limit applications, network traffic and native capabilities of the user device 102 while within the smart zone 104. The agent 218 may obtain the blocking configuration / settings from the unit 106.

The agent 218 may obtain the usage rules from the unit 106, and may track/monitor the user device location relative to the smart zone 104, responsive to obtaining the usage rules. For instance, the agent 218 may track and detect/determine whether the user device 102 may be entering the smart zone 104 via a GPS associated with the user device 102 (or the user device 102 is within the smart zone 104), as shown in a step 306. The agent 218 may receive a trigger signal from the user device processor 224 when the user device 102 is entering the smart zone 104 (e.g., via location tracking / GPS). Responsive to obtaining the trigger signal, the agent 218 may output a first notification to the unit 106 indicating that the user device 102 is entering the smart zone 104, as shown in a step 308.

In addition, the agent 218 may enable blocking based on the usage rules / blocking configuration (as shown in a step 310) when the agent 218 detects that the user device 102 is entering or has entered the smart zone 104. For instance, the agent 218 may activate VPN to route the network traffic on the user device 102 through a VPN gateway/tunnel to restrict the user device usage in the smart zone 104. In some aspects, once the VPN is activated, the agent 218 may output a second notification to the unit 106. The second notification may include an indication that the agent 218 has activated the VPN on the user device 102 based on the VPN configuration, and metadata associated with the activation (e.g., timestamp, location, etc., at which the VPN is activated).

Responsive to enabling the blocking, the unit 106 (or the processor 204) may enforce network-level controls or activate the restriction on the user device usage based on the usage rules when the user device 102 is located in the smart zone 104, as shown in a step 312. In some aspects, the unit 106 may enforce network-level controls or activate the restriction on the user device’s usage via the VPN gateway. The unit 106 may further log or store all the activities (including metadata obtained from the agent 218). The unit 106 may enforce the restrictions based on the usage rules stored in the usage rules database 212. For example, the unit 106 may disable all the third party applications 220 (or selective third party applications) for the user device 102 during 8 AM till 3 PM on weekdays. In another example, the unit 106 may block the internet in designated areas, such as the library and/or examination halls to prevent sharing of materials or cheating. Similarly, the unit 106 may temporarily activate the restrictions during an event or assembly so that the users may focus on the event / assembly, rather than on the user devices. In addition or alternatively, the agent 218 may enforce network-level controls or activate the restriction on the user device usage based on the usage rules.

In some aspects, responsive to enabling the blocking, the agent 218 may additionally monitor compliance state (or compliance status) associated with the user device 102 when the user device 102 is located in the smart zone 104. The compliance state may indicate the state of the predefined permission(s) for the agent 218 to enable the unit 106 to enforce the restriction on the user device 102. Specifically, the agent 218 may monitor and determine whether the user has disabled the predefined permission(s) for the agent 218 to operate. For example, the agent 218 may determine if the user has disabled location tracking feature on the user device 102, which may prevent the agent 218 from tracking the user device’s real-time location. In addition, the agent 218 may determine if the user has disabled the VPN connection, which may prevent the agent 218 from activating the VPN based on the VPN configuration. The agent 218 may transmit information or details associated with the compliance state to the unit 106 at a predefined frequency (or based on a trigger signal), as shown in a step 316.

In further aspects, the agent 218 may continuously monitor and actively block the user device usage when the user device 102 is located inside the smart zone 104, as shown in a step 314. For instance, when the unit 106 disables access to the internet on the user device 102 (e.g., to enforce the restrictions on the user device 102), the agent 218 may monitor if the user is still using the user device 102 in the offline mode. The agent 218 may further monitor the user device usage (e.g., screen time) inside the smart zone 104. The agent 218 may transmit such information to the unit 106 (e.g., the processor 204) at step 316. In some aspects, the agent 218 may capture/monitor the user device usage information (e.g., screen time) even when the user disables the predefined permission(s) and transmit such information to the unit 106 (e.g., the processor 204).

The processor 204 (or the unit 106) may obtain the information or details associated with the compliance state and/or the usage information from the agent 218 and may store the obtained information in the memory 206. For instance, the processor 204 may store such information / data in the user information database 214. Further, responsive to obtaining the information associated with the compliance state, the processor 204 may determine or track / monitor whether the user device 102 is in a compliant state or in a non-compliant state based on the obtained information, as shown in a step 318. The user device 102 may be in a non-compliant state when the user has disabled the predefined permission(s) (e.g., the location tracking feature and/or the VPN) for the agent 218 to operate properly. In additional aspects, the processor 204 may determine that the user device 102 may be in a non-compliant state when the user removes/deletes the agent 218 from the user device 102 (e.g., when the processor 204 stops receiving any data from the agent 218). On the other hand, the user device 102 may be in the compliant state when the agent 218 has the predefined permission to operate properly on the user device 102 and the user has not removed the agent 218 from the user device 102. Responsive to determining that the user device 102 is in the non-compliant state, the processor 204 may perform one or more remedial actions, as shown in a step 320.

In some aspects, the remedial action may include outputting a third notification to the user device 102 requesting the user to enable the predefined permission for the agent 218 to operate properly. The processor 204 may output the third notification at a predefined frequency until the user provides the predefined permission to the agent 218. In further aspects, the remedial action may include outputting a fourth notification to a third party, indicating that the user has disabled the predefined permission. For instance, the processor 204 may output the fourth notification to user devices associated with the supervisor of the user, the user’s parents, and/or to the administrator. In addition, the processor 204 may output a notification to the user device when the user has disabled the predefined permission to the agent 218. For example, the processor 204 may output a notification “You've disabled a required setting, which violates your school’s phone policy. Your administrator has been notified.” In further aspects, the remedial action may include storing the information associated with the compliance state in the memory 206 (e.g., in the user information database 214). The processor 204 may store the details associated with the non-compliant state of the user device 102. The details may include metadata associated with the non-compliant state (e.g., day and time at which the user device 102 is found to be non-compliant, compliance rate, etc.), and/or measures taken (or remedial actions performed) to maintain the user device in the compliant state. The processor 204 may store all the instances associated with the non-compliance state in the user information database 214. Similarly, the processor 204 may store details associated with the user device usage (e.g., the screen time information) in the user information database 214.

In addition, the agent 218 may be configured to detect that the user device 102 is exiting the smart zone 104 based on monitoring of the user device location, as shown in a step 322. Responsive to such detection, the agent 218 may disable the blocking. For example, the agent 218 may deactivate the VPN or the VPN connection to deactivate the restriction on the user device 102, as shown in a step 324. Since the VPN connection is deactivated, the network traffic may not pass through the VPN gateway and the unit 106 may not enforce any restriction on the user device usage. Thus, when the user exits the smart zone 104, the user may use the user device 102 without any restriction.

The unit 106 may not only perform the operation of enforcing the restrictions on the user device usage inside the smart zone 104, but may also enable the administrator (e.g., the supervisor/teacher associated with the user or the unit developer/manager) to view the information associated with the user (and/or other users) via the admin interface 210. In some aspects, the processor 204 may obtain the user information from the external server 208, map the user information with the user device usage in the smart zone 104 and/or the non-compliant state of the user device 102, and display such mapped information on the admin interface 210. The processor 204 may further store this mapping in the memory 206 (e.g., in the user information database 214).

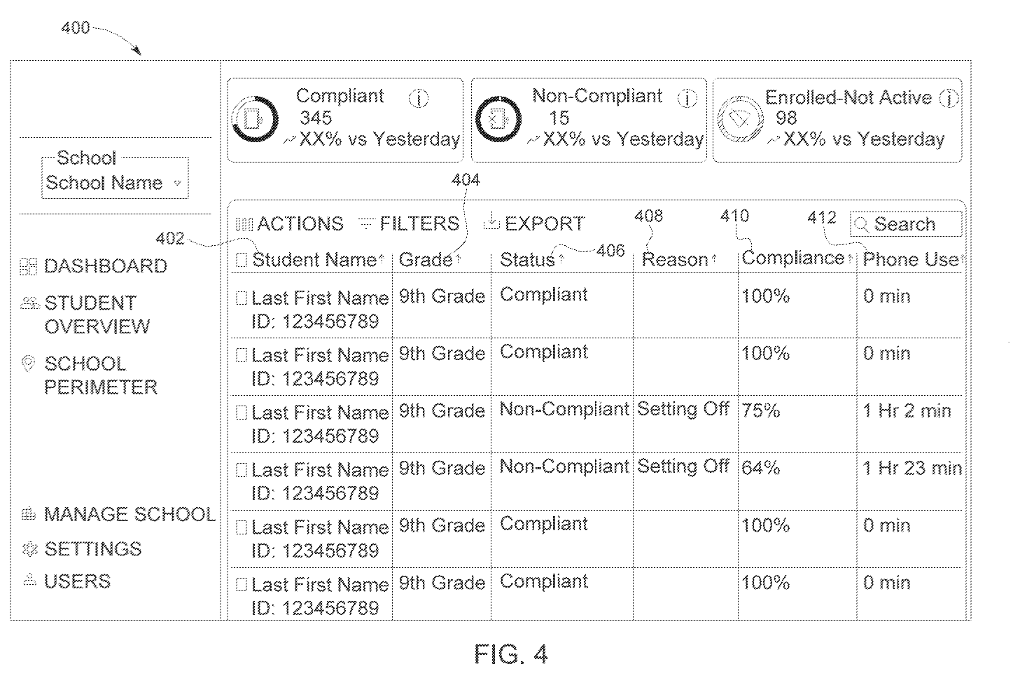

In an exemplary aspect, the processor 204 may render a dashboard 400 (shown in FIG. 4) having the user information on the admin interface 210, which enables the administrator to view the details associated with the user information (which may include the mapping described above). For instance, the processor 204 may render the non-compliant state and/or the compliant state of the user device 102 (and hence the user) on the admin interface 210. In addition, the processor 204 may render the information associated with the user device usage (e.g., a total active screen time per day) on the admin interface 210, to enable the administrator to view information associated with the user device usage via the admin interface 210. In some aspects, the processor 204 may render the dashboard 400 on the admin interface 210 when the processor 204 receives a request from the administrator to render the admin interface 210.

As shown in FIG. 4, the dashboard 400 may include/display information associated with multiple users/students associated with the education institute. The dashboard 400 depicts various user information, such as the user/student name (as shown in column 402) and grade/class associated with the user/student (as shown in column 404). In addition, the dashboard 400 may depict the status associated with the user devices associated with the respective users. For example, the dashboard 400 may depict whether the respective user device is in a compliant state or in a non-compliant state, as shown in column 406. In case the user device is in the non-compliant state, the dashboard 400 depicts a reason for the non-compliance (e.g., settings are off or the user removed the agent 218 from the user device 102), as shown in column 408. In addition, the dashboard 400 may depict a compliance rate or percentage for each user device 102, as shown in column 410. Further, the dashboard 400 may depict information associated with the user device usage, as shown in column 412. In an exemplary aspect, the dashboard 400 may depict an average screen time associated with the user device per day / month, when the user device 102 is in the non-compliant state.

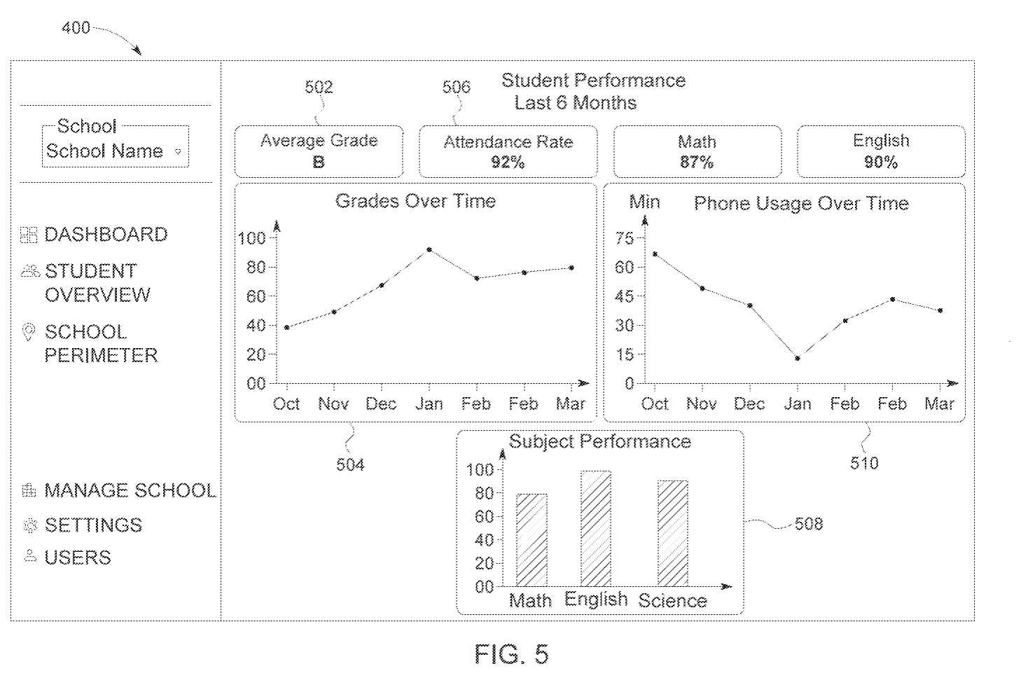

The dashboard 400 may further enable the administrator to view various details associated with a user collectively on the admin interface 210, as shown in FIG. 5. For instance, FIG. 5 depicts a user/student performance over a specific duration (e.g., last 6 months), which may enable the administrator to view different information about the user collectively, correlate all the information and counsel the user based on the correlation. In some aspects, the dashboard 400 may depict average grade associated with the user for last 6 months, as shown in view 502. In addition, the dashboard 400 may depict grades over time, as shown in view 504. The dashboard 400 may further depict attendance information associated with the user, as shown in view 506. Further, the dashboard 400 may depict subject wise performance / scores, as shown in view 508. Along with the above-mentioned information, the dashboard 400 may depict information associated with the compliant state / non – compliant state of the respective user and the user device usage information (as shown in view 510), so that the administrator may correlate the student’s performance with the user device usage in the education institute. FIG. 5 depicts charts for illustration purposes only and the dashboard 400 may depict any multi-dimensional charts to enable the administrator to view different information about the user collectively, correlate all the information and counsel the user based on the correlation.

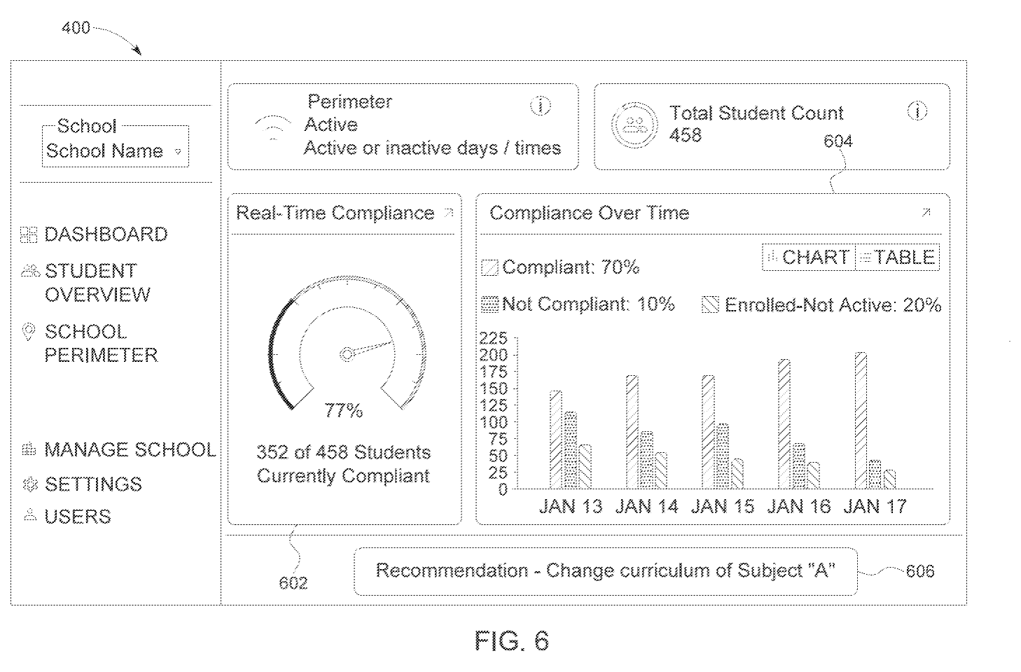

In addition, the dashboard 400 may depict overall compliance information associated with the education institute, as shown in FIG. 6. In some aspects, the dashboard 400 may depict real-time compliance status of all user devices / users associated with the education institute, as shown in view 602. For instance, the dashboard 400 may depict that 352 of 458 students are currently compliant. Further, the dashboard 400 may depict a trend of compliance status over time (e.g., for last 1 month), as shown in view 604. In some aspects, the dashboard 400 may additionally depict real-time compliance status of all user devices / users (and user device usage information) associated with multiple education institutes (e.g., in a district).

In some aspects, the processor 204 may additionally identify a trend/pattern associated with historical user device usage associated with a user in the smart zone 104. For example, the processor 204 may determine times at which the user operates the user device 102 inside the smart zone 104 (despite enforcing of the restrictions) for the last 3 or 6 months. Similarly, the processor 204 may identify the trend/pattern associated with historical compliant / non-compliant state associated with the user device 102 when the user device 102 is located in the smart zone 104, for the last 3 or 6 months.

Responsive to identifying the pattern associated with the historical user device usage (and/or the historical compliant / non-compliant state), the processor 204 may correlate the pattern with the historical user performance. The historical user performance may include assessment of the user by the user’s supervisor, such as academic grades, attendance, etc. Based on the correlation, the processor 204 may determine a recommendation to improve the user’s performance. For instance, the processor 204 may identify a trend that indicates that students of grade 9 are mostly in the non-compliant state (or use their respective user devices) between 10-11 AM (e.g., during class of subject “A”). Based on such pattern, the processor 204 may output a recommendation (as shown in view 606) on the dashboard 400 to change the curriculum of subject “A”, as the students might not be able to focus in the class of subject “A” and the changed curriculum may help. In another aspect, the processor 204 may output a recommendation to change a teaching style of subject “A” to get the attention of the supervisor. In further aspects, the processor 204 may identify the trend of multiple users (associated with a single education institute or multiple education institutes), correlate the trends, and provide a recommendation to improve the performance of users. The processor 204 may use Artificial Intelligence (AI) / Machine Learning (ML) models to determine the trends and the recommendation.

In further aspects, the processor 204 may monitor the user device usage (e.g., the screen time) associated with the user device 102 inside the smart zone 104 via the agent 218 (as described above). Based on the monitoring, the processor 204 may output a notification to the user device 102. For instance, the processor 204 may output the notification stating, “Right now is a great time to focus on learning. Try putting your phone away to stay on track.” (as a supportive prompt) or “No Phones should be out. Please put your phone away” (as a policy reminder), when the user device usage indicates that the user may be using the user device 102. In another instance, the processor 204 may output the notification stating “Nice work! You’ve followed 100% compliance today—staying focused and present. Keep it up!” (as a positive reinforcement), when the user device usage indicates that the user has not used the user device 102 during the whole day in the smart zone 104.

In further aspects, the processor 204 may identify the trend of the user device usage for 1 year (as an example) and correlate the trend with the historical user performance as described above. Based on the correlation, the processor 204 may predict a future performance outcome for the user, and may output a notification on the user device 102 indicating the predicted future performance outcome. For instance, the notification may be, “Hi user, we’ve been tracking your user device usage and your performance, and we suggest you to stay focused during these hours in this class to have a 30% better chance of getting into top 5 engineering colleges.” In some aspects, the processor 204 may predict the future performance outcome for the user based on trend analysis of other users having similar characteristics.

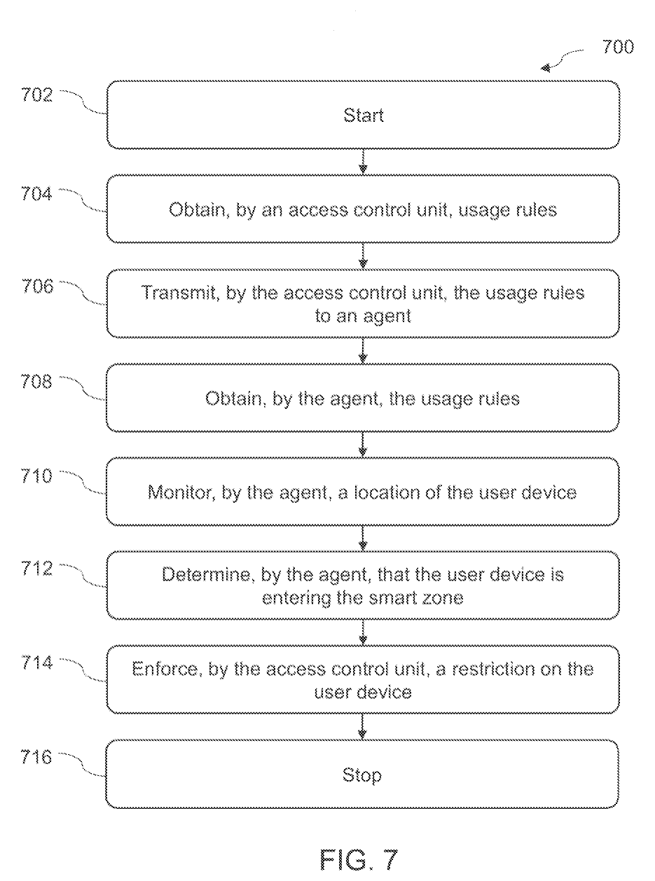

FIG. 7 depicts a flow diagram of an example method 700 to control the user device 102 in accordance with the present disclosure. FIG. 7 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 700 starts at step 702. At step 704, the method 700 may include obtaining, by the unit 106, usage rules that includes information associated with the smart zone 104 and the restriction to be enforced on the user device 102 inside the smart zone 104. At step 706, the method 700 may include transmitting, by the unit 106, the usage rules to the agent 218 responsive to obtaining the usage rules. At step 708, the method 700 may include obtaining, by the agent 218, the usage rules from the unit 106.

At step 710, the method 700 may include monitoring, by the agent 218, a user device location responsive to obtaining the usage rules. At step 712, the method 700 may include determining, by the agent 218, that the user device 102 is entering the smart zone 104 based on the monitoring of the user device location. At step 714, the method 700 may include enforcing, by the unit 106, the restriction on the user device 102 based on the usage rules when the user device 102 is located in the smart zone 104.

### At step 716, the method 700 may stop.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

What is claimed is:

1. A system comprising:
an access control unit comprising:
a memory configured to store usage rules associated with a user device of a user; and
a processor configured to:
obtain the usage rules from the memory, wherein the usage rules comprise information associated with a predefined area and a restriction to be enforced on the user device inside the predefined area;
transmit the usage rules to an agent located on the user device responsive to obtaining the usage rules; and
enforce the restriction on the user device based on the usage rules when the user device is located in the predefined area; and
the agent located on the user device, wherein the agent is communicatively coupled to the access control unit, wherein the agent comprises instructions stored thereupon which, when executed by a user device processor, cause the user device processor to:
obtain the usage rules from the access control unit;
monitor a location of the user device responsive to obtaining the usage rules;
determine that the user device is entering the predefined area based on the monitoring of the location of the user device; and
enable the access control unit to enforce the restriction on the user device, responsive to determining that the user device is entering the predefined area.

2. The system of claim 1, wherein the agent comprises instructions stored thereupon which, when executed by the user device processor, further cause the user device processor to activate a virtual private network (VPN) based on the usage rules to enable the access control unit to enforce the restriction on the user device.

3. The system of claim 2, wherein the agent comprises instructions stored thereupon which, when executed by the user device processor, further cause the user device processor to:
determine that the user device is exiting the predefined area based on the monitoring of the location of the user device; and
deactivate the VPN to deactivate the restriction on the user device, responsive to determining that the user device is exiting the predefined area.

4. The system of claim 1, wherein the restriction to be enforced on the user device comprises deactivation of at least one of: third party applications, a network, or other device functionality associated with the user device.

5. The system of claim 1, wherein the usage rules further comprise information associated with at least one of: a defined time-period of the day to enforce the restriction, a defined day to enforce the restriction, or a defined location or zone in the predefined area to enforce the restriction.

6. The system of claim 1, wherein the usage rules further comprise a blocking configuration, and wherein the agent comprises instructions stored thereupon which, when executed by the user device processor, cause the user device processor to enable blocking based on the blocking configuration.

7. The system of claim 1, wherein the agent comprises instructions stored thereupon which, when executed by the user device processor, cause the user device processor to:
continuously monitor a compliance status associated with the user device, wherein the compliance status is associated with a predefined permission for the agent to enable the access control unit to enforce the restriction on the user device; and
transmit information associated with the compliance status to the access control unit.

8. The system of claim 7, wherein the processor is further configured to:
obtain the information associated with the compliance status from the agent;
determine that the user device is in a non-compliant state based on the information, wherein the user device is in the non-compliant state when the user disables the predefined permission for the agent; and
perform a remedial action responsive to a determination that the user device is in the non-compliant state.

9. The system of claim 8, wherein the predefined permission comprises at least one of: a permission to track the location of the user device, or a permission to establish a VPN connection to enable the processor to enforce the restriction on the user device.

10. The system of claim 8, wherein, to perform the remedial action, the processor is configured to perform at least one of:
output a first notification to the user device, requesting the user to enable the predefined permission for the agent; or
output a second notification to a third party device, indicating that the user has disabled the predefined permission for the agent.

11. The system of claim 8, wherein, to perform the remedial action, the processor is configured to store details associated with the non-compliant state in the memory, and wherein the details comprise at least one of: metadata associated with the non-compliant state, or remedial actions taken to maintain the user device in a compliant state.

12. The system of claim 11, wherein the processor is further configured to render a dashboard on an admin interface that enables an administrator to view the details associated with the non-compliant state for the user device.

13. The system of claim 12, wherein the agent comprises instructions stored thereupon which, when executed by the user device processor, cause the user device processor to:
monitor a user device usage in the predefined area; and
transmit information associated with the user device usage to the access control unit based on the monitoring.

14. The system of claim 13, wherein the processor is further configured to:
obtain the information associated with the user device usage from the agent;
store the information associated with the user device usage in the memory; and
render the information associated with the user device usage on the admin interface.

15. The system of claim 14, wherein the processor is further configured to:
determine a pattern associated with historical user device usage in the predefined area based on the information associated with the user device usage stored in the memory;
correlate the pattern with a historical user performance, wherein the historical user performance comprises assessment of the user by a supervisor;
predict a future performance outcome for the user based on the correlation; and
output a third notification on the user device indicating the future performance outcome.

16. The system of claim 15, wherein the processor is further configured to determine a recommendation to improve a user performance based on the correlation, and wherein the recommendation comprises a modification of a curriculum.

17. The system of claim 14, wherein the predefined area is associated with an education institute and the usage rules are associated with the education institute, and wherein the processor is further configured to:
obtain user information associated with the user from an external server associated with the education institute;
map the user information with the user device usage in the predefined area or the non-compliant state of the user device; and
store the mapping in the memory.

18. The system of claim 17, wherein the processor is further configured to:
generate a unique quick-response code for the user device responsive to obtaining the user information; and
enable the user to install the agent using the unique quick-response code to communicatively couple the user device with the access control unit.

19. A method comprising:
obtaining, by an access control unit, usage rules that comprise information associated with a predefined area and a restriction to be enforced on a user device inside the predefined area;
transmitting, by the access control unit, the usage rules to an agent located on the user device responsive to obtaining the usage rules;
obtaining, by the agent, the usage rules from the access control unit;
monitoring, by the agent, a location of the user device responsive to obtaining the usage rules;
determining, by the agent, that the user device is entering the predefined area based on the monitoring of the location of the user device; and
enforcing, by the access control unit, the restriction on the user device based on the usage rules when the user device is located in the predefined area.

20. A non-transitory computer-readable storage medium having instructions stored thereupon which, when executed by a processor, cause the processor to:
obtain, by an access control unit, usage rules that comprise information associated with a predefined area and a restriction to be enforced on a user device inside the predefined area;
transmit, by the access control unit, the usage rules to an agent located on the user device responsive to obtaining the usage rules;
obtain, by the agent, the usage rules from the access control unit;
monitor, by the agent, a location of the user device responsive to obtaining the usage rules;
determine, by the agent, that the user device is entering the predefined area based on the monitoring of the location of the user device; and
enforce, by the access control unit, the restriction on the user device based on the usage rules when the user device is located in the predefined area.
